(19) United States
(12) Patent Application Publication
(10) Pub. No.: US 2007/0143448 A1
(43) Pub. Date: Jun. 21, 2007

(54) Mobile terminal and method for connecting to a web site and managing connection information

(75) Inventor: Jeong Hyo Yi, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/498,760

(22) Filed: Aug. 4, 2006

(30) Foreign Application Priority Data
Dec. 16, 2005 (KR) 2005-0124793

(51) Int. Cl. G06F 15/16

(52) U.S. Cl. 709/219

(57) ABSTRACT

A mobile terminal and a method for quickly accessing the internet are provided. The mobile terminal comprises a radio frequency (RF) unit which performs access to a web site through the Internet, an access information collector which collects access information of the web site, a web access configuration unit which configures shortcut keys, on an input interface, corresponding to the web site access information as web connection settings information, a storage unit which stores the web connection settings information, and a controller which retrieves the web connection settings information linked to the shortcut key from the storage unit if shortcut information is input through the input interface and outputs the web connection settings information through an output interface, accesses to the web site based on the web site access information included in the web connection settings information through the RF unit when a web access command is input through the input interface.

### CROSS-REFERENCE TO RELATED APPLICATIONS

This application claims the benefit under 35 U.S.C. §119(a) of a Korean Patent Application, Serial No. 2005-0124793, filed in the Korean Intellectual Property Office on Dec. 16, 2005, the entire contents of which is hereby incorporated by reference.

### BACKGROUND OF THE INVENTION

1. Field of the Invention

The present invention relates to a mobile terminal. More particularly, the present invention relates to a mobile terminal and method for quickly accessing the internet.

2. Description of the Related Art

Developments in mobile communication technologies have produced mobile terminals equipped with multiple functions such as the typical voice communication and short message service. For example, internet access which is typically carried out with personal computers is also available through the mobile terminal.

Internet access is available through mobile terminals such as cellular phones and personal digital assistants (PDA), among others.

The internet access with the mobile phone is available by expanding the conventional wired Internet to the wireless networks. This type of mobile phone is equipped with a wireless web browser for searching web sites over the Internet.

FIG. 1 is a block diagram illustrating an Internet access system using a typical mobile phone.

As shown in FIG. 1, the Internet access system comprises a mobile terminal 10, a base station 22, a base station controller 24, a mobile switching center 26, a network interface 28, a proxy server 32, a web server 34, and a plurality of web sites 36 and 38.

The base station 22 communicates with the mobile terminal 10 through a wireless channel. The base station controller 24 controls the operation of the base station and transfers the data from the mobile terminal 10 via the base station 22 to the mobile switching center 26, and transfers the data received from the mobile switching center 26 to the mobile terminal 10 via the base station 22.

The mobile switching center 26 performs a switching function for routing the data transmitted from the mobile terminal 10, and the network interface 28 provides the interface between the wireless network and wired network. The proxy server 32 provides a connection between the network interface 28 and the web server 34. The web server 34 manages the web sites and supports the access to the web sites. The web sites 36 and 38 supply the information required by the users and are accessed by the mobile terminal 10 through the web server 34.

FIG. 2 is a flowchart for illustrating a method for accessing Internet with a conventional mobile terminal.

Once an Internet access command is input, the mobile terminal 10 operates a previously installed wireless web browser at step S12. The mobile terminal 10 then connects to the web server 34 using the wireless web browser at step S14.

The mobile terminal 10 extracts the address of the web site to be visited from the input command and transmits the web site address information to the web server 34 at step S16. Upon receiving the web site address information, the web server 34 retrieves an Internet Protocol (IP) address corresponding to the received web site address information at step S18. The web server 34 sequentially maps the web site of the retrieved IP address to the mobile terminal 10 at step S22 and connects the mobile terminal 10 to the web site through the Internet at step S24.

However, the conventional web site connection method in a mobile terminal takes a long time to approach an intended web site due to the complex and difficult steps for retrieving the web site.

The conventional web site connection method requires unnecessary charges due to the time consuming processes for accessing the Internet, such as, inputting an IP address of the web site.

Also, the conventional web site connection method does not provide a favorite web site management function. Even when the favorite web site management function is provided, the web sites are managed only with icons or web site titles. This makes it difficult for the users to recognize their services.

### SUMMARY OF THE INVENTION

An aspect of exemplary embodiments of the present invention is to address at least the above problems and/or disadvantages and to provide at least the advantages described below. Accordingly, an aspect of an exemplary embodiment of the present invention is to provide a mobile terminal and method for accessing a web site.

According to an exemplary embodiment of the present invention, a mobile terminal and method is provided for facilitating quick access to a web site by managing information on the web sites independently.

Another object of an exemplary embodiment of the present invention is to provide a mobile terminal and method for providing the user with information on the managed web sites to facilitate quick access thereto.

The above objects are achieved by using a mobile terminal to support an internet connection function. The mobile terminal supports Internet access and comprises a radio frequency (RF) unit, an access information collector, a web access configuration unit, and a storage unit. The RF unit performs access to a web site through the Internet and the access information collector collects access information of the web site. The web access configuration unit configures shortcut keys on an input interface which correspond to the web site access information as web connection settings information. The storage unit stores the web connection settings information and the controller retrieves the web connection settings information linked to the shortcut key from the storage unit if shortcut information is input through the input interface and outputs the web connection settings information through an output interface. Access to the web site is gained based on the web site access information comprised in the web connection settings information through the RF unit when a web access command is input through the input interface.

According to an exemplary implementation, the web connection settings information comprises history information on the connections to the web site.

According to an exemplary implementation, the web site access information comprises web server information to support a connection to the web site through the RF unit, internet address information of the web site, and introduction information of the web site.

The web site introduction information comprises a page information of the web site, title information set for the web site, and detailed guide information of the web site.

According to an exemplary implementation, the detailed guide information comprises text, video, or voice information.

The input interface is a key interface and the shortcut information is number key information. Also, the output interface is a display unit for displaying the web connection settings information on a screen.

In another aspect of an exemplary embodiment of the present invention, a method for accessing Internet using the mobile terminal is provided. Access information of a web site connected through the Internet is collected and shortcut keys of an input interface corresponding to the web site access information are configured as web connection settings information. The web connection settings information is stored and the web connection settings information linked to the shortcut key is retrieved from the storage unit when shortcut information is input. The web connection settings information is output through an output interface and the web site is accessed based on the web site access information comprised in the web connection settings information when a web access command is input.

According to another aspect of an exemplary embodiment of the present invention, the mobile terminal supporting Internet access comprises a radio frequency (RF) unit, an access information collector, a web access configuration unit, a storage unit, and a controller. The RF unit performs access to a web site through the Internet and an access information collector collects access information of the web site. The web access configuration unit configures number keys on an input interface which correspond to the web site access information as web connection settings information The storage unit stores the web connection settings information and the controller retrieves the web connection settings information linked to a number key from the storage unit if the number key is input and displays the web connection settings information on a screen. Access to the web site is gained based on the web site access information comprised in the web connection settings information through the RF unit when a web access command is input.

The controller displays a number corresponding to a pushed key at a predetermined area of the screen while the web connection settings information is displayed.

In accordance with an exemplary embodiment of the present invention, the wireless internet connection to the web site is performed so that the mobile terminal collects information required to connect to the web site, links the items of the information to the number keys and stores and manages the links as the web connection settings information. The connection to the website also facilitates the display of the web connection settings information linked to a number if the number is input while the web connection settings information is displayed, and facilitates connection to the web site corresponding to the web connection settings information displayed according to the web access command. This makes it possible to check the information associated with the web site without internet connection, efficiently manage the internet connections, and to quickly connect to the web site if necessary.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 is a block diagram illustrating an Internet access system using a typical mobile phone;

FIG. 2 is a flowchart illustrating a method for accessing the Internet with a conventional mobile terminal;

FIG. 3 is a block diagram illustrating a mobile terminal according to an exemplary embodiment of the present invention;

FIG. 4 is a block diagram illustrating a structure of the web connection settings information of FIG. 3;

FIG. 5 is a block diagram illustrating the web connection information of FIG. 4 in more detail;

FIG. 6 is a table displaying the web connection settings information of FIG. 4 and FIG. 5;

FIG. 7 is a flowchart illustrating a web site access method using a mobile terminal according to an exemplary embodiment of the present invention;

FIG. 8 is a flowchart illustrating the web site configuration step of FIG. 7 in detail;

FIG. 9 is a flowchart illustrating the web connection information collection step of FIG. 8 in more detail;

FIG. 10A is an exemplary view illustrating a web connection settings information corresponding to an input number key;

FIG. 10B is an exemplary view illustrating web access setting information corresponding to the number input by the corresponding number key; and

FIG. 10C is an exemplary view illustrating a result connected to the web site included in the web connection settings information.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

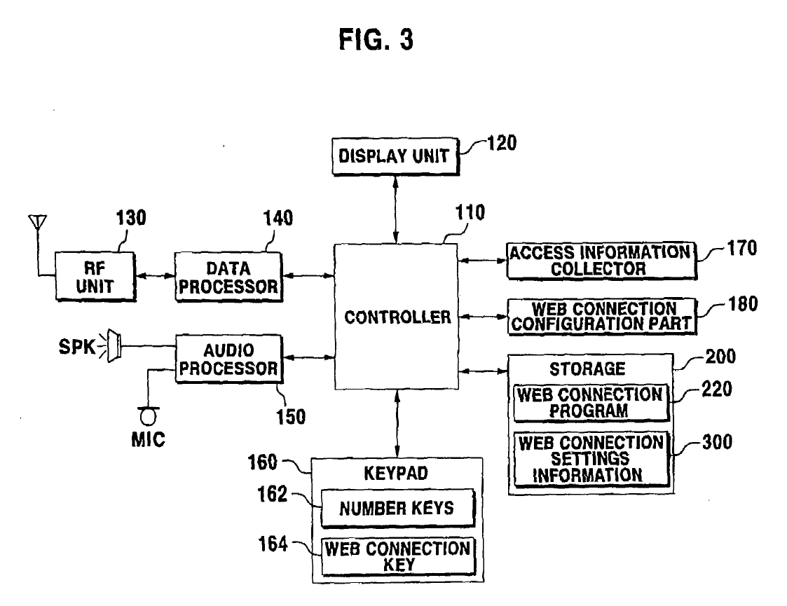

FIG. 3 is a block diagram illustrating a mobile terminal according to an exemplary embodiment of the present invention.

As shown in FIG. 3, the mobile terminal comprises a controller 110, a display unit 120, RF unit 130, a data processor 140, an audio processor 150, a keypad 160, an access information collector 170, a web connection configuration unit 180, and a storage unit 200.

The controller 110 controls entire operations of the mobile terminal 110. The controller 110 manages data and voice communication with a counterpart terminal by controlling the RF unit 130, data processor 140, and audio processor 150. The mobile terminal is able to access the Internet and to connect to a web site under the control of the controller 110. Also, the controller 110 collects the information required to connect to the web site and manages the collected information.

The display unit 120 displays an operation state of the mobile terminal on a screen by the controller 110. The display unit 120 may be a Liquid Crystal Display (LCD), which will be equipped together with an LCD controller, a memory, and an LCD display device among others. The LCD display can be implemented using a touchpad functions which allows the screen to be used as an input interface. The display unit 120 displays the information associated with the web site under the control of the controller 110.

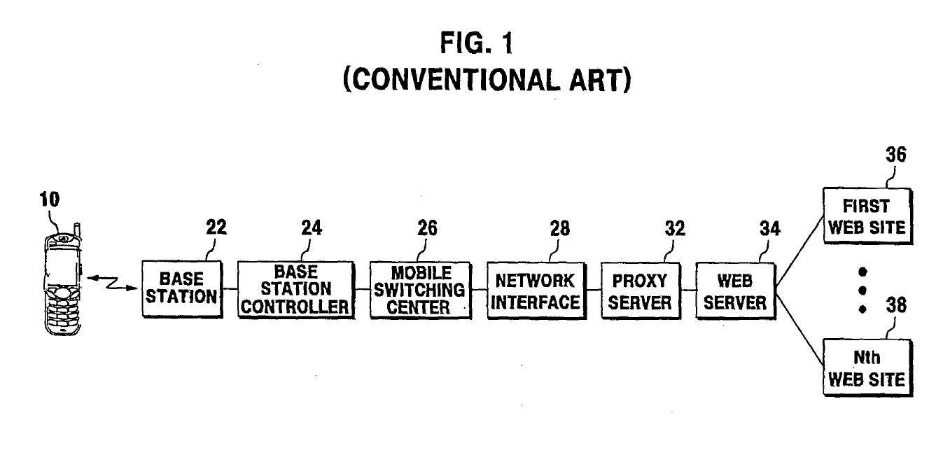

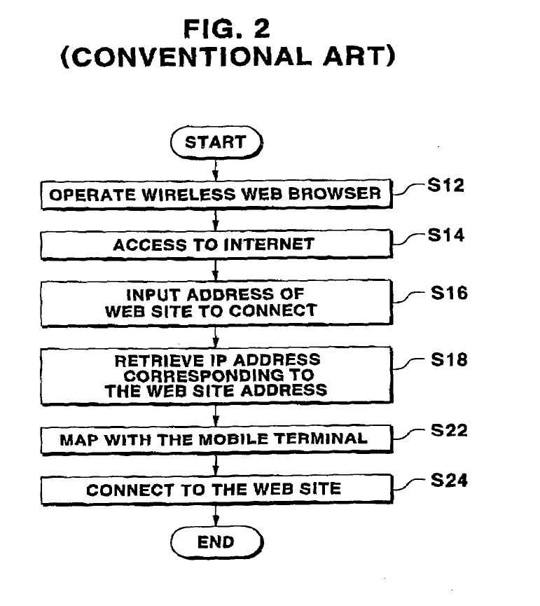

The RF unit 130 receives and transmits data through the air and comprises a RF transmitter for up converting the signal to be transmitted and an RF transmitter which low-noise amplifies the received signal and down converts the amplified signal. Also, the RF unit 130 provides the web site information received through the air channel to the data processor 140 and transmits the web site access request information received from the data processor to a web server (340 in FIG. 1).

The data processor 140 is provided with a transmit module which performs encoding and modulation on the signal before transmitting and a receive module which performs demodulation and decoding on the signal received through the RF channel. The data processor 140 demodulates the web site information received through the RF channel and then provides the demodulated web site information to the controller 110. Also, the data processor 140 modulates the web site access request information and transfers the modulated web site access request information to the RF unit 130.

The audio processor 150 can be implemented with codecs, such as, a data codec for processing the packet data and an audio codec for processing the audio signals. The audio processor 150 converts digital audio signals received from the data processor 140 into analog audio signals using the audio codec and the outputs the analog audio signal through a speaker. Also, the audio processor 150 converts analog signals input through a microphone into digital audio signals using the audio codec and then transfers the digital audio signals to the data processor 140 via the controller 110. The codecs can be additionally provided or be built in the controller 110.

The audio controller 150 can decode the audio data provided by the web site and included in the information required for accessing the web site and output the decoded audio data through the speaker in accordance with another exemplary embodiment of the present invention.

The keypad 160 is provided with a plurality of keys for inputting numbers and characters and control keys for manipulating the operation of the mobile terminal. The keypad 160 comprises number keys 162 linked to the previously configured web connection information and a web connection key 164 for inputting a web site access instruction to the web site access information displayed according to the selection of one of the number keys 162.

The access information collector 170 collects the information required to utilize the information provided by the web site visited through the wireless Internet. The information comprises relaying server information, the address information, and the introduction information for the web site.

The web access configuration unit 180 integrally configures and manages the information required to access the web site on the basis of the information collected by the web information collector 170. The web access configuration unit 180 links items of the information collected by the web information controller 170 to the corresponding number keys of the keypad 160 and stores the information on the number keys and the corresponding items of the web connection information into the storage unit 220.

The storage unit 220 can be provided with a program memory unit, and a data memory unit, among others. The program memory unit stores the programs for controlling typical operation of the mobile terminal and the web connection program for accessing the web site through the wireless Internet. Also, the storage unit 200 stores web connection settings information 300 configured by the web access configuration unit 180. The web connection settings information 300 is explained with reference to the drawings.

According to an exemplary embodiment of the present invention, the controller 110 detects whether any of the number keys 162 are pushed while the mobile terminal is in the waiting mode. If there is a number key input, the controller 110 retrieves the web connection settings information linked to the input key in the storage unit 200 and displays the information on the display unit 120. In another exemplary embodiment of the present invention, the controller 110 detects whether any of the number keys 162 is pushed after the mobile terminal transitions from the waiting mode to the web connection settings information display mode. If there is a number key input, the controller 110 can retrieve the web connection settings information linked to the input key in the storage unit 200 and display the information on the display unit 120.

While the web site settings information is displayed under the control of the controller 110 according to the above embodiments, the numbers input by the keys can be shown in a predetermined area of the screen, such as the bottom of the screen.

In accordance with another exemplary embodiment of the present invention, the controller 110 can display the numbers linked to the corresponding web connection settings information at the bottom of the screen so that the user may easily select any of the numbers with the direction keys to obtain the web connection settings information.

If there is an input of the web connection key 164 for the web connection settings information, the controller 110 operates the web connection program stored in the storage unit 200 and requests the Internet access to the web server 34 (see FIG. 1) through the wireless network with the web site address included in the web connection settings information displayed on the screen. In response to the request, the controller 110 receives the web site information corresponding to the request and displays the web site information through the display unit 120, resulting in a connection to the web site.

In accordance with another exemplary embodiment of the present invention, a call button instead of the web connection key is pushed on the keypad 160 while the web connection settings information corresponding to the selected number key is displayed. The controller requests a call to the caller number corresponding to the input numbers. For example, if the web connection key 164 is pushed after the numbers ‘023456789’ are input and the registered web connection settings information corresponding to one of the numbers (9 in this example) is displayed on the screen, the controller 110 gains access to the web site. Alternatively, if the call button is pushed, the controller 110 regards ‘023456789’ as a phone number to request a call connection to the phone number.

The web connection information collector 170 collects the web connection settings information and compares the collected information with the web connection settings information 300 stored in the storage unit 200, and then updates the web connection settings information 300 if the web connection settings information has been changed.

Accordingly, the wireless internet connection to the web site is performed so the mobile terminal collects information required for connecting to the web site, links the items of the information to the number keys and stores and manages the links as the web connection settings information. The mobile terminal displays the web connection settings information linked to a number if the number is input while the web connection settings information is displayed, and connects to the web site corresponding to the web connection settings information displayed according to the web-access command. This makes it possible to check the information associated with the web site without internet connection, efficiently manage the internet connections, and quickly connect to the web site if necessary.

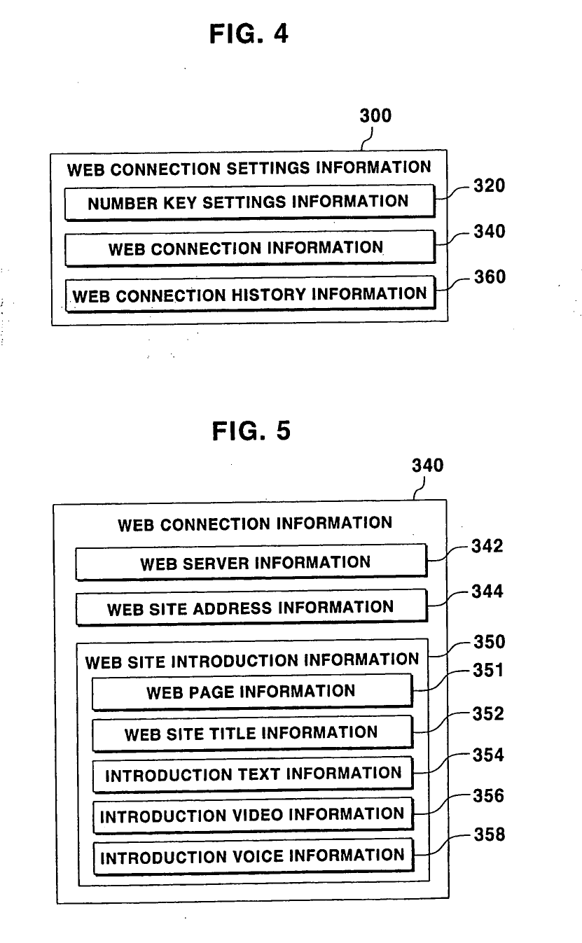

FIG. 4 is a block diagram illustrating a structure of the web connection settings information of FIG. 3.

As shown in FIG. 4, the web connection settings information 300 comprises number key setting information 320, web connection information 340, and web connection history information 360.

The number key setting information is the information on the numbers linked for displaying web connection settings information 300. Accordingly, a number key (for example, ‘2’) is pushed to input the selection command. The controller 10 retrieves the information corresponding to the pushed key and then displays the web connection settings information linked to the corresponding input number.

The web connection information 340 comprises the information on the web site configured by the web access configuration unit 180 among the information collected by the access information collector 170 and the information required for connecting to the web site.

The web connection history information 360 comprises the histories of the frequency with which certain web sites included in the web connection information 340 are accessed.

FIG. 5 is a block diagram illustrating the web connection information 340 of FIG. 4 in more detail.

As shown in FIG. 5, the web connection information 340 comprises web server information 342, web site address information 344, and web site introduction information 350.

The web server information 342 is the information on the web server which provides a relay function facilitating the connection of the mobile terminal to a web site. The web site address information 344 is IP address information of the corresponding web sites. The web site introduction information 350 comprises the introductions associated with the corresponding web sites provided by the web site designers.

Here, the web site introduction information 350 may comprise web page information 351, web site title information 352, introduction text information 354, introduction video information 356 and introduction voice information among others.

The web page information 351 is initial image information provided when a connection to the web site is made. The web site title information is for the title of the web site provided by the web site owner (for example, ‘Intellectual Property Office’ and ‘Naver’).

The introduction text information 354 is the text information provided by the site owner to introduce the web site, the introduction video information 356 is the video clip to introduce the web site, and the introduction voice information 358 is the voice information to introduce the web site.

In this embodiment, the above information 340 is collected by the access information collector 170.

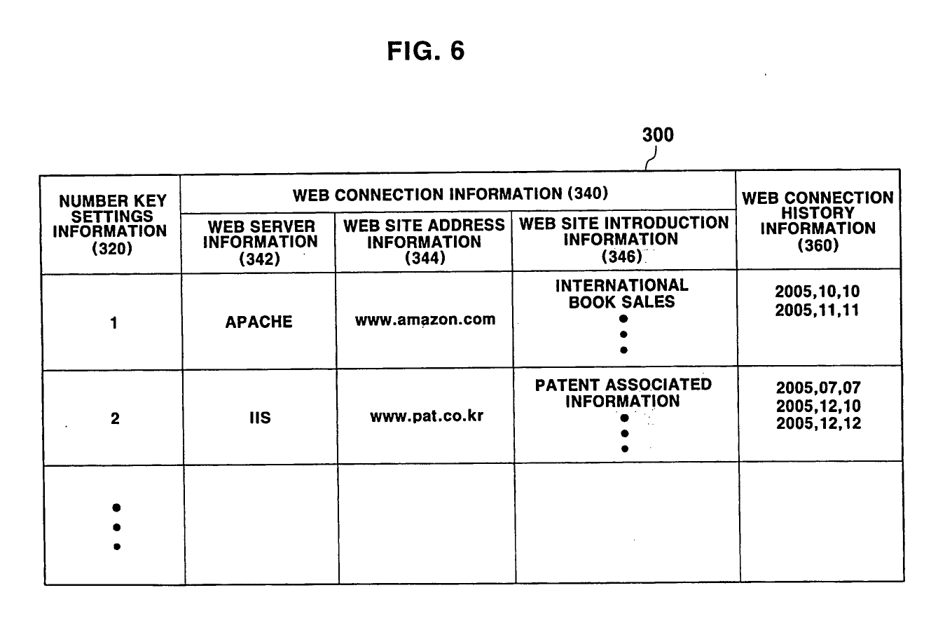

FIG. 6 is a table illustrating the web connection settings information 300 of FIG. 4 and FIG. 5.

As shown in FIG. 6, the web connection settings information 300 comprises the number key setting information 320, the web connection information 340, and web connection history information 360. The web connection information 340 comprises the web server information 342, the web site address information 344, and web site introduction information 346.

In FIG. 6, the web server information 342 shows ‘Apache Web Server,’ the web site address information 334 shows www.amazon.com. The web site introduction information 346 shows ‘international book sales . . . ,’ and the web connection history information 360 shows ‘2005,10,10’ and ‘2005,11,11.’

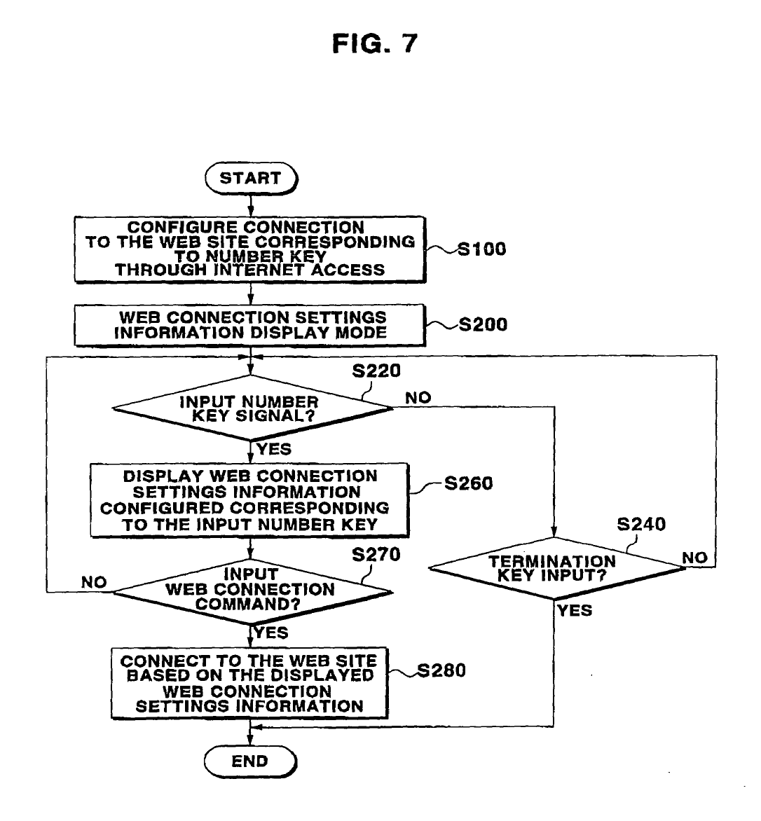

FIG. 7 is a flowchart illustrating a web site access method using a mobile terminal according to an exemplary embodiment of the present invention.

The controller 110 configures the access information on the web site corresponding to the number key 162 by controlling the access information collector 170 and the web access configuring unit 180 at step S100.

If a command for executing the web connection settings information display mode is input after the configuration of the web access settings of the web site is completed, the controller 110 switches the present operation mode to the web connection settings information display mode at step S200.

Sequentially, the controller 110 determines whether any of the number keys linked to the web connection settings information is input in the web connection settings information display mode at step S220. If no number key input exists, the controller 110 determines whether there is a key input for terminating the web connection settings information display mode at step S240. If a determination is made that there is a mode termination key input, the controller 110 terminates the present operation mode.

If a determination is made that a number key is pushed at step S220, the controller 110 retrieves the web connection settings information corresponding to the input number key from the storage unit 200 and displays the web connection settings information on the screen through the display unit 120 at step S260. While the web connection settings information corresponding to the number key is displayed, the controller 110 determines whether the web access command is input at step S270.

If the web access command is not input, the controller 110 performs steps S200 to S260. Alternatively, if the web access command is input, controller 110 operates the web connection program 220 so as to connect to the corresponding web site according to the web connection settings information displayed on the screen at step S28.

Accordingly, the wireless connection to the web site is performed so that the mobile terminal collects information required for connecting to the web site, links the items of the information to the number keys, stores and manages the links as the web connection settings information, displays the web connection settings information corresponding to the number key input in the web connection settings information display mode, and connects to the web site indicated by the displayed web site settings information when the web access command is input. This makes it possible to efficiently manage the information required for connecting to the web site and to quickly connect to the web site if necessary.

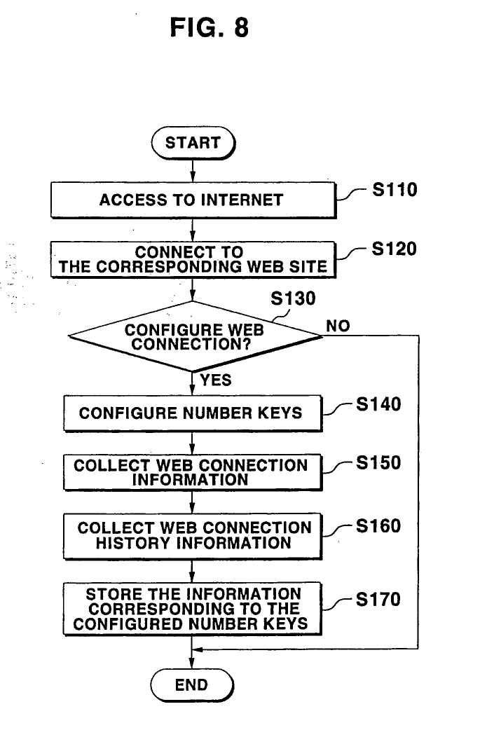

FIG. 8 is a flowchart illustrating the web site configuration step S100 of FIG. 7 in detail.

The controller 110 operates the web connection program 220 to perform the typical internet connection through the RF unit 130 at step S110. If a web site address is input, the controller tries to connect to the web site corresponding to the input address at step S120. The controller sequentially displays the web information (such as, a web page) provided by the connected web site through the display unit 120.

While connecting to the web site, the controller 110 determines whether the web access configuration command is input through the keypad at step S130. If the web access configuration command is input, the controller 110 enters the web access settings mode and configures the key information input by pushing the number keys of the keypad 160 as the number key settings information 320 at step S140.

The controller 110 sequentially controls the access information collector 170 to collect the web connection information required for connecting the web site. Also, the controller 110 controls the access information collector 170 to collect the history information on the connections with the web site at step S160. Next, the controller 110 integrates the key information set with the number keys and the web connection information and the web connection history information and then stores the integrated information into the storage unit as the web connection settings information at step S170.

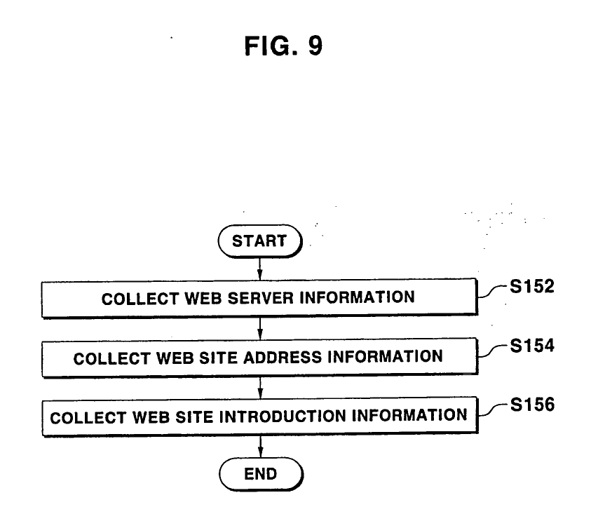

FIG. 9 is a flowchart illustrating the web connection information collection step S150 of FIG. 8 in more detail.

In FIG. 9, the controller controls the access information collector 170 to collect the information on the web server which relays the mobile terminal to the connected web site. After the web server information is collected, the controller 110 controls the access information collector to collect the address information on the connected web site at step S154. After the web site address information is obtained, the controller 110 collects the instruction information on the connected web site by controlling the access information collector 170 at step S156.

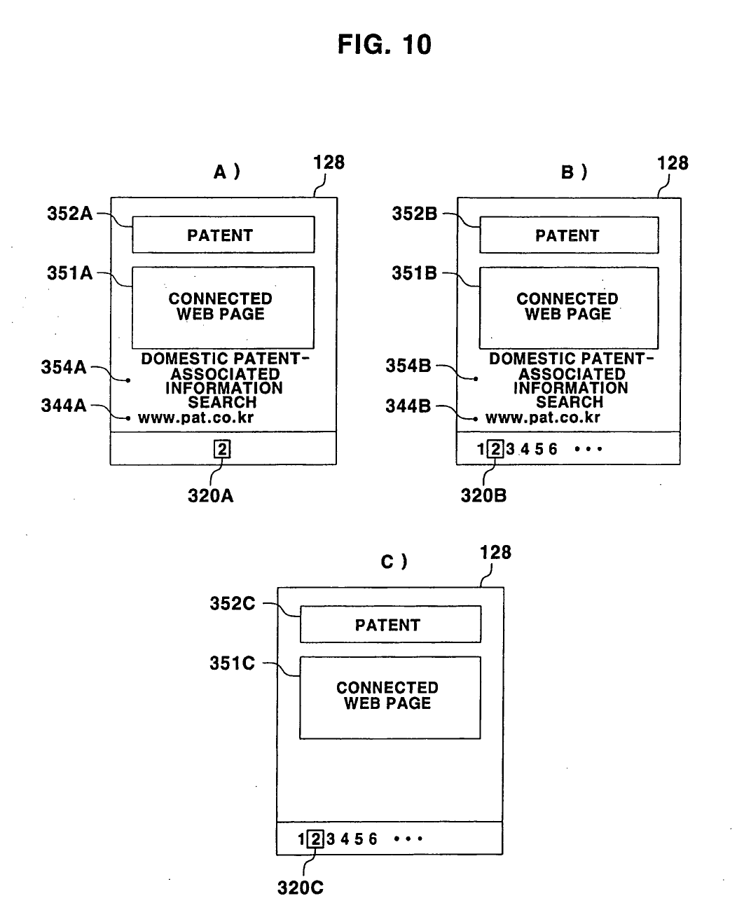

FIG. 10A is an exemplary view illustrating a web connection settings information corresponding to an input number key, FIG. 10B is an exemplary view illustrating web access setting information corresponding to the number input by the corresponding number key, and FIG. 10C is an exemplary view illustrating a result connected to the web site included in the web connection settings information.

In an exemplary implementation as illustrated in FIG. 10a, the input number (‘2’) 320a is displayed at the bottom of the screen 128, together with a web site title (‘patent’) 352A, a web site introduction (‘domestic patent-associated information search . . . ’) 354a, and a web site address (‘www.pat.co.kr’) 344a is displayed in the main area.

In FIG. 10b, the numbers (‘1, 2, 3, 4, 5, . . . ’) 320b are set to correspond to the web connection settings information comprising the input number ‘2’ are displayed at the bottom of the screen 128, together with a web site title (‘patent’ in this embodiment) 352B, a web site introduction (‘domestic patent search . . . ’ in this embodiment) 354b, and a web site address (‘www.pat.co.kr’ in this embodiment) 344b displayed in main area.

As shown in FIG. 10c, the numbers (‘1, 2, 3, 4, 5, . . . ’) 320c are set to correspond to the web connection settings information comprising the input number ‘2’. The numbers 320c are displayed at the bottom of the screen 128, together with a web site title (‘patent’) 352C and a web page 351c of the connected web site.

In an exemplary embodiment of the present invention, the mobile terminal collects information required to connecting to the web site, links the items of the information to the number keys and stores and manages the links as the web connection settings information. The mobile terminal displays the web connection settings information corresponding to the number key input in the web connection settings information display mode and connects to the web site indicated by the displayed web site settings information when the web access command is input. This makes it possible to know the information associated with the web site, to efficiently manage the internet access, and to quickly connect to the web site if necessary.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A mobile terminal supporting Internet access, comprising:
a radio frequency (RF) unit for accessing a web site;
an access information collector for collecting access information of the web site;
a web access configuration unit for configuring at least one shortcut key, on an input interface, corresponding to the web site access information as web connection settings information;
a storage unit for storing the web connection settings information; and
a controller for retrieving the web connection settings information linked to the at least one shortcut key from the storage unit if shortcut information is input through the input interface, and for outputting the web connection settings information through an output interface;
wherein the web site is accessed based on the web site access information in the web connection settings information through the RF unit when a web access command is input through the input interface.

2. The mobile terminal of claim 1, wherein the web connection settings information comprises history information on the connections to the web site.

3. The mobile terminal of claim 1, wherein the web site access information comprises at least one of web server information for supporting a connection to the web site through the RF unit, internet address information of the web site, and introduction information of the web site.

4. The mobile terminal of claim 3, wherein the web site introduction information comprises at least one of page information of the web site, title information set for the web site, and detailed guide information of the web site.

5. The mobile terminal of claim 4, wherein the detailed guide information comprises at least one of text, video, and voice information.

6. The mobile terminal of claim 1, wherein the input interface comprises a key interface.

7. The mobile terminal of claim 6, wherein the shortcut information comprises number key information.

8. The mobile terminal of claim 1, wherein the output interface comprises a display unit for displaying the web connection settings information on a screen.

9. A method for accessing the Internet using a mobile terminal, the method comprising:
collecting access information of a web site;
configuring at least one shortcut key of an input interface corresponding to the web site access information as web connection settings information;
storing the web connection settings information;
retrieving the web connection settings information linked to the at least one shortcut key from the storage unit when shortcut information is input;
outputting the web connection settings information through an output interface; and
accessing to the web site based on the web site access information in the web connection settings information when a web access command is input.

10. The method of claim 9, wherein the web connection settings information comprises history information relating to the connections to the web site.

11. The method of claim 9, wherein web site access information comprises at least one of web server information for supporting a connection to the web site through the RF unit, Internet address information of the web site, and introduction information of the web site.

12. The method of claim 11, wherein the web site introduction information comprises at least one of page information of the web site, title information set for the web site, and detailed guide information of the web site.

13. The method of claim 12, wherein the detailed guide information comprises at least one of text, video, and voice information.

14. The method of claim 9, wherein the input interface comprises a key interface.

15. The mobile terminal supporting Internet access, comprising:
a radio frequency (RF) unit for accessing a web site;
an access information collector for collecting access information of the web site;
a web access configuration unit for configuring at least one key, on an input interface, corresponding to the web site access information as web connection settings information;
a storage unit for storing the web connection settings information; and
a controller for retrieving the web connection settings information linked to the at least one key from the storage unit if the at least one key is input, and for displaying the web connection settings information on a screen;
wherein the web site is accessed based on the web site access information in the web connection settings information through the RF unit when a web access command is input.

16. The mobile terminal of claim 15, wherein the controller displays a number corresponding to the at least one input on at least a portion of the screen while the web connection settings information is displayed.

17. The mobile terminal of claim 15, wherein the web site access information comprises at least one of web server information for supporting connection to the web site through the RF unit, internet address information of the web site, and introduction information of the web site.

18. The mobile terminal of claim 17, wherein the web site introduction information comprises at least one of page information of the web site, title information set for the web site, and detailed guide information of the web site.
